(19) United States
(12) Patent Application Publication
(10) Pub. No.: US 2017/0215568 A1
(43) Pub. Date: Aug. 3, 2017

(54) TOOTHBRUSH HEAD AND A CHILD'S TOOTHBRUSH INCORPORATING THE SAME

(71) Applicant: Apollonia Health Inc, Hamilton (CA)

(72) Inventors: Joon Kim, Hamilton (CA); Duane Hewitt, Hamilton (CA); Bogdan Damjanovic, Hamilton (CA)

(73) Assignee: Apollonia Health Inc

(21) Appl. No.: 15/010,709

(22) Filed: Jan. 29, 2016

(51) Int. Cl. A46B 9/04; B29C 45/00; B29C 45/14; B25G 1/10

(52) U.S. Cl. CPC A46B 9/04; B25G 1/102; B29C 45/0003; B29C 45/14336; A46B 2200/1066; B29K 2021/00

(57) ABSTRACT

A head for a toothbrush, a toothbrush incorporating the toothbrush head and a method of fabricating the same is disclosed. The toothbrush head includes a bulbous body that is located at one end of a handle. The body includes first and second ends and a longitudinal axis extending therebetween. The body comprises a first disc and at least a second disc located generally vertically below the first disc. Each disc has a peripheral surface with a plurality of facetted regions formed therein. The facets may include detents and indentations. The peripheral surface may also include a plurality of cylindrical rod-like projections that extend radially outwardly therefrom and are oriented at right angles to the longitudinal axis. The toothbrush is fabricated by injection molding an inner core from a rigid material and then injection molding a resilient layer around that core.

### BACKGROUND OF THE INVENTION

Technical Field

This invention relates generally to oral care products. More particularly this invention is directed to a toothbrush. Specifically, the invention relates to a toothbrush for younger children that includes a rigid inner core and a resilient outer layer, where the outer layer of the head of the toothbrush includes a plurality of stacked discs having faceted outer surfaces that may include rod-like projections for sweeping across gum tissue and teeth.

Background Information

Parents of young children, particularly those just beginning to teethe, need to brush their infant's newly emerged teeth in order to clean those teeth and to begin training their child to adopt healthy dental habits. Infants have very few teeth in their mouth and so brushing has to be undertaken carefully because of the possible contact with soft gum tissue. The types of bristle tufts typically provided on adult-style toothbrushes could irritate the gum tissue and cause pain, particularly if the gums are somewhat swollen because of teething.

As the child grows older and starts to learn to brush their own teeth a new challenge arises because of the lack of fully developed fine motor skills. The child has to learn the brush motions and simultaneously control the force they apply when they brush. If a toothbrush includes the type of bristle tufts typically found on adult-style toothbrushes, then a younger child's vigorous and slightly uncontrolled brushing can lead to accidental injury of the soft gum tissue in their mouth.

In order to address these, several companies have developed toothbrushes for infants that are in the form of some type of teething device. These devices take advantage of the fact that young children like to put things in their mouths and that when they are teething, they like to bite down on things. These devices may include a handle that is easy to grip and a head that is soft and resilient and easy to chew. U.S. Pat. No. 5,571,140 (Gura-Emerling) for example, includes a bulbous handle with two differently configured attachments that are selectively connectable to the handle. A first attachment includes a shaft with a rounded body at one end. The body includes a plurality of raised bumps that simulate toothbrush bristles. This rounded body is used as a teething device that the young child can bite down on and the bumps will possibly remove some particulate matter that may be on the teeth. The second attachment includes a shaft with a trainer toothbrush-style head on one end. The toothbrush end includes a plurality of bristles that all extend outwardly from one face of the toothbrush head in generally the same direction. The first attachment will be used when the child is young and the second attachment will be used as the child grows older and has more mature teeth.

U.S. Pat. No. D383,307 (Klein et al) discuses a combination infant toothbrush and teething unit. The device includes an elongate shaft with a toothbrush at one end and a teething unit at the other end. The shaft includes a plurality of raised bumps on its exterior surface that make it easier to grip. The teething unit includes a bulbous, generally “football-shaped” end with a plurality of nubs radiating outwardly from the exterior surface in all directions. The toothbrush end also includes a bulbous, generally “football-shaped” end with a plurality of bristle tufts radiating outwardly in all directions.

Spence, Jr. (D345,054 and D350,851) discloses two infant massager toothbrushes. Each toothbrush includes an elongate handle that is similar to the types of handles used on typical manual toothbrushes for adults. The toothbrush head in each case is a bulbous member. D345,054 shows a plurality of bristle elements extending outwardly from one surface of the toothbrush head in generally the same direction. D350,851 shows a plurality of bristle elements radiating outwardly from all surfaces of the brush head.

There are other types of toothbrushing or teething devices that are free of bristle tufts. These devices may be provided instead with a plurality of rubber filaments or nubs that will be brought into contact with the teeth as the child chews on the device or as the device is moved across the teeth by the child or by a caregiver. One example of a teething ring type of “toothbrush” includes a range of toothbrushes sold under the trademark Baby Banana® by Live-Right, LLC of Wilmington, Del. Other examples of such toothbrushes are the gum massagers sold under the trademark zoli® by Zoli, Inc. of Burlingame, Calif.; or the training toothbrushes sold under the trademark Nuk® by MAPA, GmbH of Germany.

### SUMMARY

While all these abovementioned toothbrushes and teething devices address some of the issues relating to brushing the teeth of infants and young children, there remains a need in the art for a toothbrush that is easy to use on the teeth of a baby or for young child.

A head for a toothbrush, a toothbrush incorporating the toothbrush head and a method of fabricating the same is disclosed herein. The toothbrush head includes a bulbous body that is located at one end of a handle. The body includes first and second ends and a longitudinal axis extending therebetween. The body comprises a first disc and at least a second disc located generally vertically beneath the first disc. The first and second discs may be vertically aligned with each other. Each disc has a peripheral surface with a plurality of facetted regions formed therein. The facets may include detents and indentations. The peripheral surface may also include a plurality of cylindrical rod-like projections that extend radially outwardly therefrom and are oriented at right angles to the longitudinal axis. The toothbrush is fabricated by injection molding an inner core from a rigid material and then injection molding a resilient layer around that core.

The toothbrush disclosed herein is free tufts of bristles such as those that are typically found on manual toothbrushes. Typical bristles and tufts of bristles, such as those found on manual adult-style toothbrushes, may be too aggressive for tender gums that are teething. These bristles may also be too ticklish and foreign feeling to the child and they may therefore not cooperate during the brushing event.

Instead, the toothbrush disclosed herein includes a bulbous end that is molded from an elastomer and is configured to include a plurality of discs separated from each other by gaps. The discs may include a plurality of resilient rod-like filaments that are molded from the same elastomeric material as the discs. The discs may have a multi-faceted exterior surface that may include regions that project outwardly and other regions that are recessed. Any rod-like filaments may extend outwardly from the exterior surface from the regions that project outwardly or are recessed or are smooth and convexly shaped.

The toothbrush disclosed herein is designed to be used in order to train a child to brush their teeth and develop good dental habits from infancy up until the time their teeth are fully mature. The toothbrush is used by a caregiver on an infant and may simply be used on gum tissue or on newly emerging teeth as the infant child ages. Initially, the parent or caregiver may use a version of a toothbrush that has a smooth and rounded shape at one end. That smooth rounded “toothbrush” may be similar in shape and texture to a nipple of a rubber pacifier/soother. Still later as the child ages and their teeth continue to come in and mature, the parent or caregiver could apply dentrifice (i.e., toothpaste or powder for cleaning the teeth) to the head end of the bristleless toothbrush (which includes resilient discs that a free of cylindrical projections) disclosed herein and move the toothbrush end of that device over the teeth and gums to stimulate the gums and clean any emerging teeth. As the child grows older and more or all of their teeth have emerged, the type of toothbrush used may be another version of the brush disclosed herein that includes a plurality of resilient discs and rod-like cylindrical projections that extend outwardly from the outer surfaces of the discs. Once the child is a little older, they can perform the then familiar brushing task by themselves. Finally, when the child's teeth are fully grown and the child has mastered brushing skills, the child may graduate to using a toothbrush that includes typical tufts of bristles.

The toothbrush disclosed herein may include a plurality of discs along with rod-like projections that fan out through 90°, 180° or 360°. Brushes that include the rod-like projections that fan out through 90° and 180° have to be rotated in the child's mouth to brush both upper and lower teeth. Typically someone else is brushing the child's teeth and because there is no tactile feedback and frequently obscured vision for the person performing the brushing action, the 360° version of the brush disclosed herein resolves the need for having to flip the brush around. The 360° version of the toothbrush minimizes the need to turn the brush over as it is able to brush teeth in almost any direction and at almost any angle.

The multi-disc head of the toothbrush disclosed herein is also effective at holding dentrifice, mouthwash, or any other fluid paste between the discs and dispersing it slowly during brushing.

In one aspect, the invention may provide a toothbrush head for a toothbrush, wherein the toothbrush head comprises a bulbous body adapted to be located at one end of a handle; wherein said body includes a first end and a second end and a longitudinal axis extending between the first and second ends; and wherein the body comprises a first disc; a second disc located generally vertically below the first disc; wherein each of the first and second discs has a peripheral surface; and a plurality of facetted regions formed on the peripheral surface of each of the first and second discs. The discs may extend through 90° or 180° or 360° of the outer circumference of the brush head.

In another aspect, the invention may provide a method of fabricating a head for a toothbrush comprising forming an inner core out of a rigid material; forming an outer layer around the inner core out of a resilient material; and forming a plurality of discs in the outer layer; wherein the discs are oriented at right angles to a longitudinal axis of the inner core. The step of forming a plurality of discs includes molding the discs to include a faceted peripheral surface and cylindrical projections that extend outwardly therefrom.

In another aspect, the invention may provide a method of training a child to brush their teeth using a toothbrush; where the child ages from infancy up to when their teeth are fully mature; said training method comprising the steps of brushing an infant child's teeth with a toothbrush having a head that resembles a nipple of an infant soother; brushing the young child's emerging teeth and gum tissue with a toothbrush having a head that comprises a plurality of resilient discs which each have multi-faceted outer surfaces; brushing the older child's teeth with a toothbrush having a head that comprises a plurality of resilient discs which each have multi-faceted outer surfaces and include a plurality of cylindrical projections extending outwardly from the outer surfaces; and brushing the child's fully mature teeth with a toothbrush having a head that incudes a plurality of bristle tufts.

### BRIEF DESCRIPTION OF THE SEVERAL VIEWS OF THE DRAWINGS

A sample embodiment of the invention is set forth in the following description, is shown in the drawings and is particularly and distinctly pointed out and set forth in the appended claims.

FIG. 1 is a bottom perspective view of a toothbrush in accordance with an aspect of the present invention;

FIG. 2 is a top perspective view thereof;

FIG. 3 is a front elevational view thereof;

FIG. 4 is side elevational view thereof;

FIG. 5 is an enlarged top plan view thereof;

FIG. 6 is an enlarged bottom plan view thereof;

FIG. 7 is an enlarged bottom perspective view of the highlighted region of FIG. 1;

FIG. 8 is an enlarged top perspective view of the highlighted region of FIG. 2;

FIG. 9 is an enlarged front elevational view of the highlighted region of FIG. 3;

FIG. 10 is an enlarged side elevational view of the highlighted region of FIG. 4;

FIG. 11 is a longitudinal cross-section of the toothbrush taken along line 11-11 of FIG. 3;

FIG. 12 is a longitudinal cross-section of the toothbrush taken along line 12-12 of FIG. 4;

FIG. 13 is a front elevational view of a second embodiment of a toothbrush in accordance with an aspect of the present invention;

FIG. 14 is an enlarged front elevational view of the highlighted region of FIG. 14;

FIG. 15 is an enlarged perspective view of a third embodiment of the head of the toothbrush;

FIG. 16 is an enlarged front elevational view of the head of the toothbrush shown in FIG. 15;

FIG. 17 is a cross-section of the toothbrush head taken along line 16-16 of FIG. 16;

FIG. 18 is an enlarged perspective view of a fourth embodiment of the head of the toothbrush;

FIG. 19 is an enlarged front elevational view of the head of the toothbrush shown in FIG. 18; and

FIG. 20 is a cross-section of the toothbrush head taken along line 20-20 of FIG. 19.

Similar numbers refer to similar parts throughout the drawings.

### DETAILED DESCRIPTION

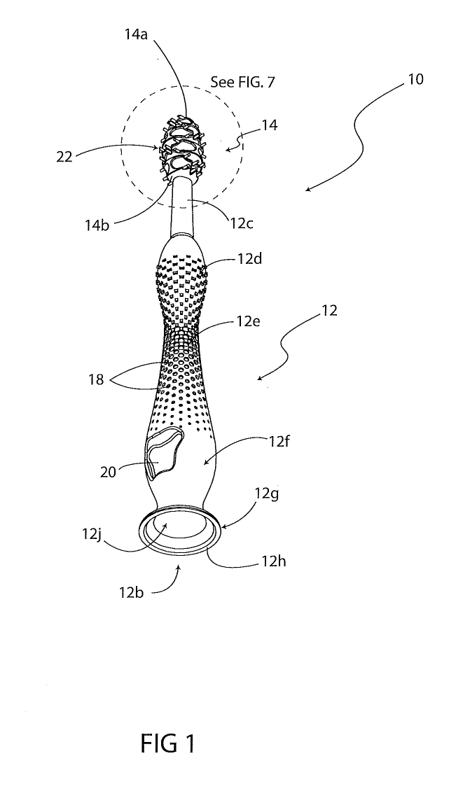

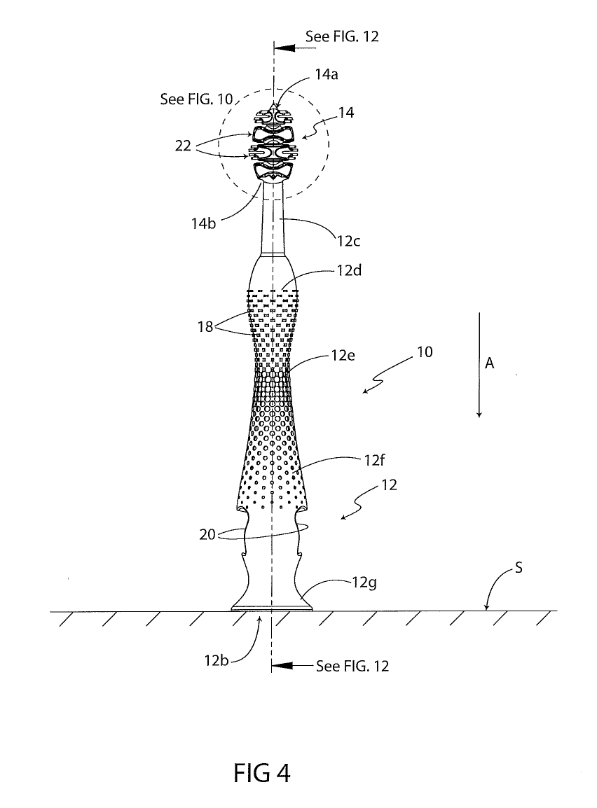

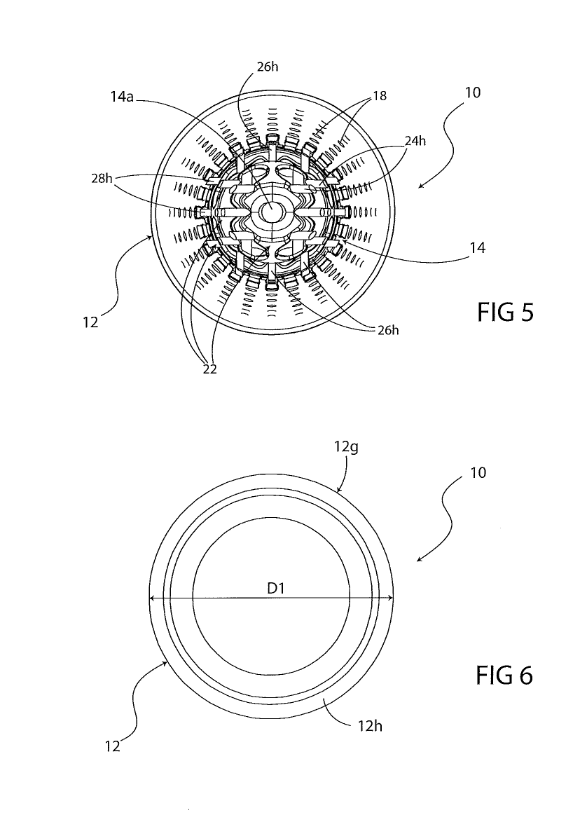

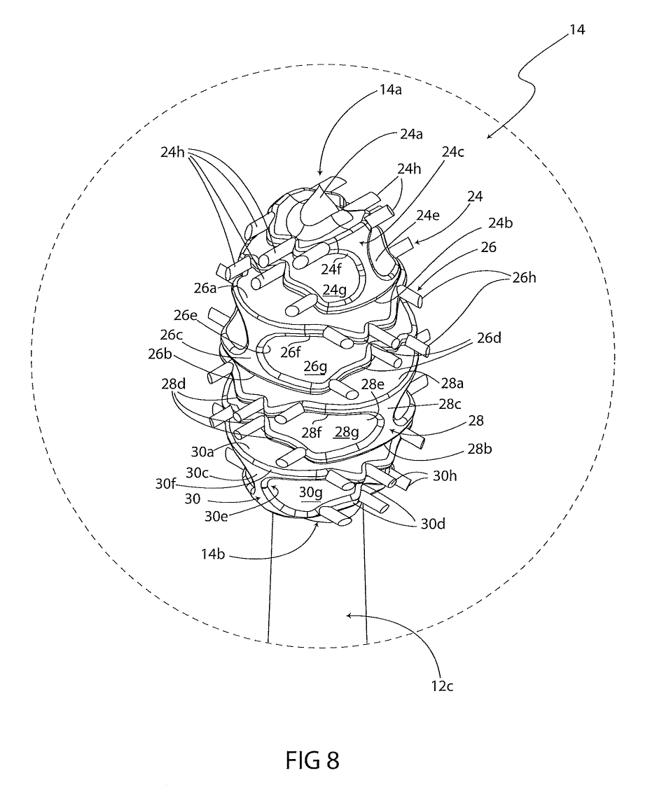

Referring to FIGS. 1-12, there is shown a first embodiment of a toothbrush in accordance with an aspect of the present invention, generally indicated at 10. Toothbrush 10 may include a handle 12 and a head 14. Handle 12 and head 14 may be molded components as will be described later herein.

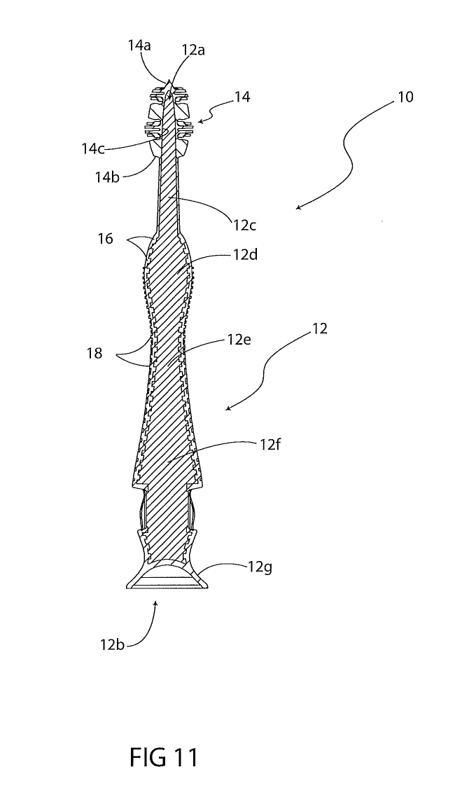

Handle 12 may be an elongate structure that has a first end that engages head 14 and a second end that may be configured to stand handle 12 upon a surface. The first end of handle 12 is indicated by the reference number 12a in FIGS. 11 & 12 and the second end of handle 12 is indicated by the reference number 12b therein. Handle 12 may comprise a shaft 12c, a first bulbous region 12d, a neck 12e, a second bulbous region 12f and a base 12g. Shaft 12c may increase in diameter from first end 12a toward second end 12b and terminate in an upper region of first bulbous region 12d. In other words, shaft 12c tapers from first bulbous region 12d to first end 12a. First bulbous region 12d may be narrower proximate the upper region thereof, become wider and then narrow again proximate neck 12e. Second bulbous region 12f may be narrower proximate neck 12e, become wider moving towards second end 12b of handle 12 and then narrow again proximate base 12g. Base 12g may be narrower proximate second bulbous region 12f and then flare outwardly towards second end 12b. Second bulbous region 12f may be wider at is widest diameter than the widest region of first bulbous region 12d. The exterior shape of handle 12 may be such that it is ergonomically shaped so as to be easily grasped and held by a younger child. The transition regions between shaft 12c and first bulbous region 12d; between first bulbous region 12d and neck 12e; between neck 12e and second bulbous region 12f; and between second bulbous regions 12f and base 12g may be gently curved and therefore present no sharp edges that might accidentally injure the child.

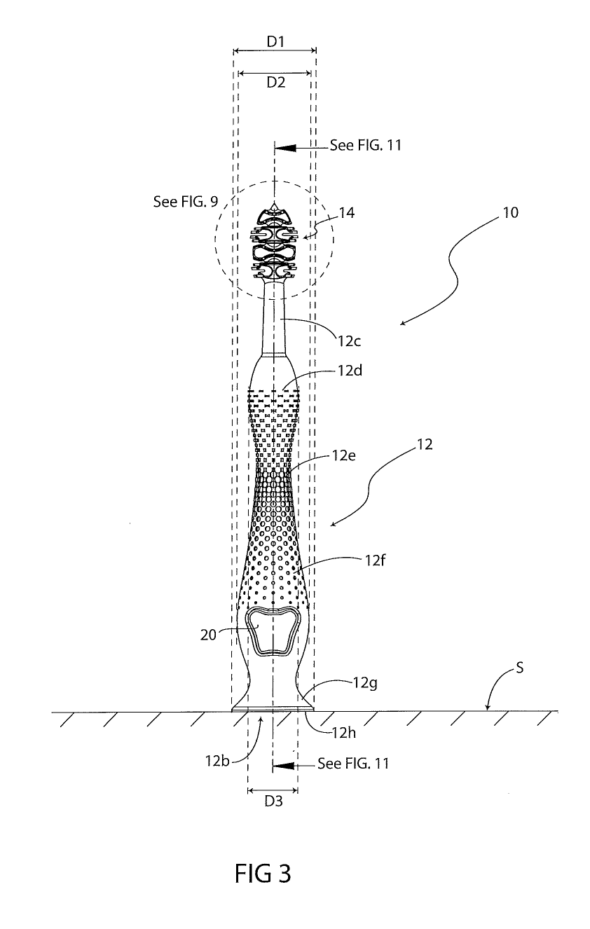

Base 12g may include an annular bottom surface 12h that forms the second end 12b of handle 12. As best seen in FIG. 3, this annular bottom surface 12h may be substantially flat and therefore be ideal for placing on a flat surface so that toothbrush 10 may be positioned in an upright or vertical orientation on that surface. All of the various parts of handle 12 may be generally circular in cross-section and present no components that require handle 12 to be held in any particular orientation. So, for instance, handle 12 may be free of any flat surface or finger or thumb placement regions.

Base 12g may have a maximum diameter “D1” at bottom surface 12h. The maximum diameter of second bulbous region 12f may be similar to diameter “D1” or may be slightly smaller and be of a diameter “D2” (FIG. 3). First bulbous region 12d may have an even smaller maximum diameter “D3”. Neck 12e and shaft 12c may be of even smaller maximum diameters than first bulbous region 12d.

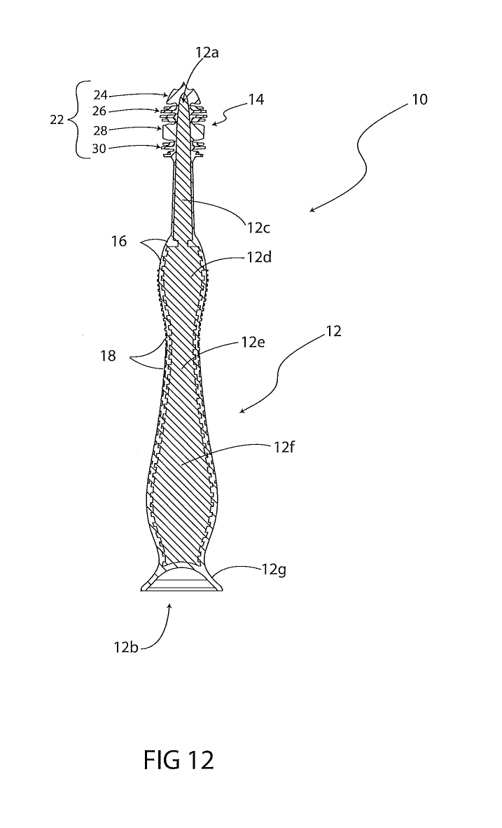

Handle 12 may be fabricated to include an inner core (shown in FIGS. 11 and 12 by cross-hatching) and a sheath 16 that surrounds that inner core. The inner core may be comprised of fairly rigid plastic such as ABS (Acrylonitrile butadiene styrene) or other similar plastic materials. Inner core may be fabricated by injection molding. Once the inner core has been injection molded, that molded inner core may be placed into yet another mold. A soft rubber, TPR (thermoplastic rubber) or any other suitable elastomeric material may be injected into the mold and around inner core. The elastomeric material molds to form a resilient elastomeric sheath around at least a part of or all of the inner core. Sheath 16 may cover only select regions of the inner core, e.g., the sheath 16 may form only the resilient part of head 14. Sheath 16 may additionally be molded to form a covering over part of handle 12. Sheath 16 may then provide for a good grip on handle 12 and add to the aesthetics of toothbrush 10. Still further, sheath 16 may be molded to cover some or all of base 12g of handle 12, as will be discussed later herein.

If sheath 16 extends to cover some of handle 12, the exterior surface of at least part of first bulbous region 12d, neck 12e and part of second bulbous region 12f may include sheath 16 and that portion of sheath 16 may be textured in some fashion. The textured exterior surface may be produced in any number of suitable ways. For example, the attached figures, particularly FIGS. 11 and 12, show a pattern of raised bumps 18 provided on handle 12. Bumps 18 may be formed in the plastic that is used to fabricate inner core. Alternatively, as illustrated in FIG. 11, bumps 18 may be formed in or on sheath 16. Instead of or in addition to bumps 18, sheath 16 or the inner core's exterior surface may include a plurality of ribs, grooves, dimples or apertures. The pattern of bumps 18 (or ribs, grooves, dimples and apertures) may not be consistent along the length of handle 12, Instead, the positioning, shape and size of the bumps 18 (or ribs, grooves, dimples apertures) may be varied along the length of handle 12. Still further, some type of texturing material, such as particulate matter (e.g. sand), could be incorporated into the rubber of handle 12 or into sheath 16.

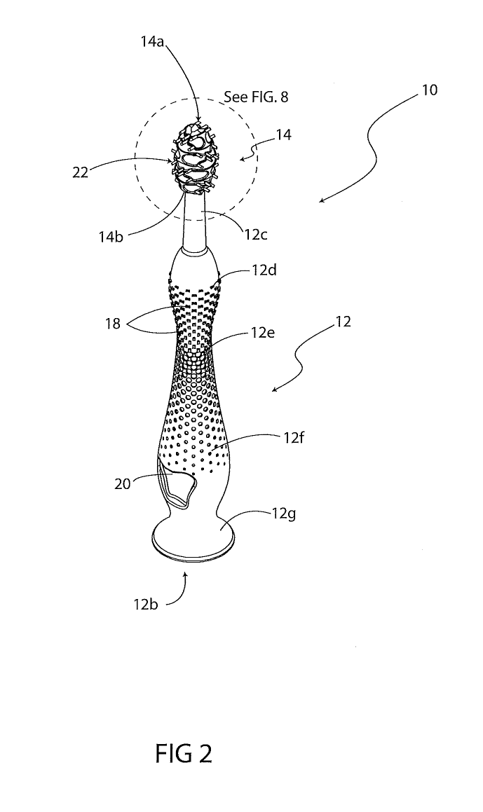

As indicated earlier herein, sheath 16 may be extend around base 12g. In particular, sheath 16 may extend around base 12g in such a manner so as to form a suction cup (shown in FIG. 2). The suction cup will help to hold toothbrush 10 in an upright or vertical position and to remain that way on a support surface “S” (FIG. 3). In this instance a cavity 12j (FIG. 1) may be defined in the underside of base 12g. Orienting toothbrush 10 vertically, as illustrated in FIG. 4, and then pushing downwardly in the direction of arrow “A” will cause air to be driven out of cavity 12j and cause base 12g to suction onto the support surface “S”.

Handle 12 may also include one or more recesses 20 that are defined along its length. As illustrated in the attached figures a pair of recesses 20 may be defined in opposing surfaces of second bulbous region 12f.

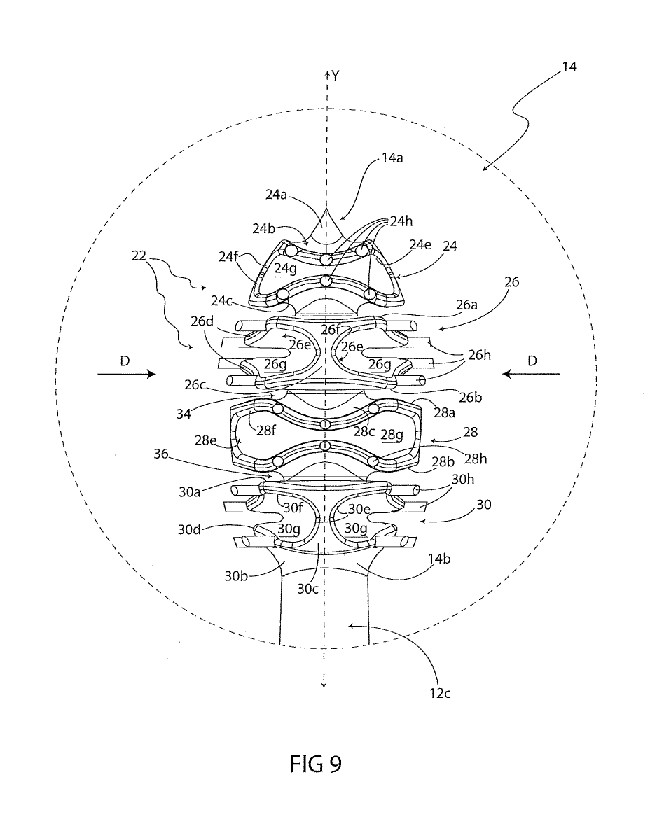

Head 14 is engaged with first end 12a of handle 12. Head 14 may be an injection molded component that is fabricated out of any suitable flexible and/or resilient material. For example, head 14 may be injection molded from rubber or a soft plastic. Head may be generally circular in cross-section and have a first end 14a (FIG. 9) and a second end 14b. Head may have a longitudinal axis “Y” extending between first end 14a and second end 14b. A recess 14c (FIG. 11) may be defined in head 14 and this recess 14c may extend longitudinally from an opening in second end 14b towards first end 14a. Recess 14c terminates a short distance inwardly from first end 14a. First end 12a of handle and a portion of shaft 12c extends through recess 14c. Since toothbrush 10 is formed by a two injection molding procedures, head 14 is injection molded around first end 12a of handle 12 and the upper end of shaft 12c. Alternatively, handle 12 and head 14 may be separately injection molded and then head 14 is inserted onto first end 12a and secured thereto by any suitable method such by heat welding or by an adhesive.

Head 14 may be molded so as to include a plurality of discs 22 (e.g. 24, 26, 28, 30). Each disc 22 may be somewhat donut-shaped in that they comprise a molded annular ring (that encircles first end 12a and upper portion of shaft 12c of handle 12). Each molded disc 22, if removed from handle 12, would include a portion of the recess 14c that extends along the midline (and longitudinal; axis “Y”) of head 14. Each disc 24-30 may be molded so as to be different in external appearance from the other discs. Uppermost disc 24 and lowermost disc 30 may taper in diameter from a middle region of head 14 towards ends 14a, 14b. This configuration would cause head 14 to be narrower proximate first end 14a, flare outwardly therefrom reaching a maximum diameter, and then tapering in diameter once again as one moves toward second end 14b. One or more centrally located discs, such as discs 26, 28, may be interposed between disc 24 and disc 30.

First disc 24 may be molded to include a tip 24a that is conical in shape and may be suitable for use as a toothpick. First disc 24 flares outwardly from a base of tip 24a and terminates in a bottom surface 24b. An annular peripheral wall 24c extends between tip 24a and bottom surface 24b. Wall 24c is of a narrower diameter closest to tip 24a and flares outwardly away therefrom and is of a greatest diameter proximate bottom surface 24b. Bottom surface 24b may include straight sections and undulating sections around its circumference.

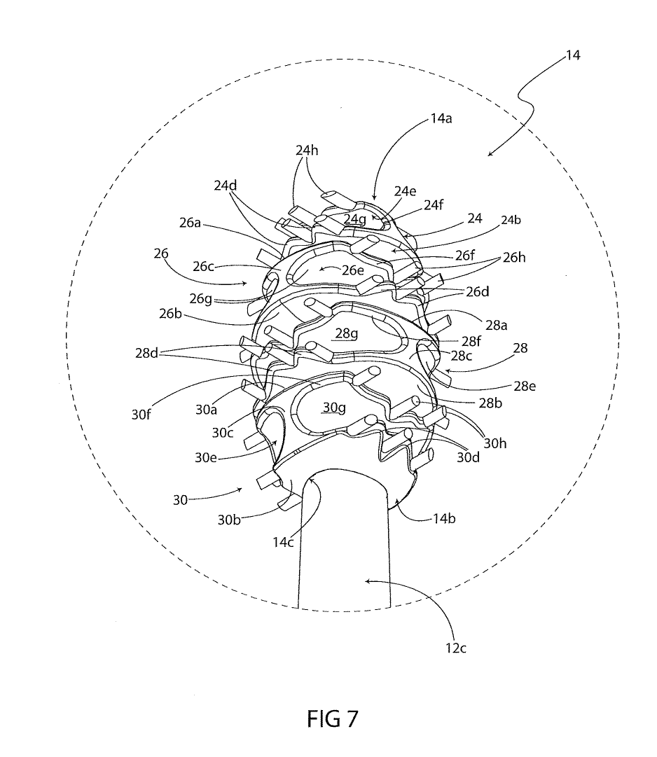

Peripheral wall 24c may also be generally undulating and include regions that are smooth and convex in shape. Peripheral wall 24c may also include detents 26d (FIG. 7) that project outwardly from wall 24c. Detents 26d may be generally V-shaped. Indentations 24e may also be provided as part of peripheral wall 24c. These indentations 24 may be recessed relative to wall 24c. Indentations 24e may include beveled edges 24f that transition to wall 24c and may also include an interior wall 24g (FIG. 9) spaced a distance inwardly from wall 24c. A plurality of generally cylindrical rod-like whiskers or projections 24h may extend outwardly from peripheral wall 24c or from detents 24d, indentions 24e, transitions 24f or interior wall 24g. Projections 24h may be spaced circumferentially from each other, may be spaced longitudinally from each other, and may be of different lengths. Each projection 24h may be oriented generally horizontally and at right angles to longitudinal axis “Y” of head 14 and extend radially outwardly therefrom. First disc 26 is thus a multi-faceted disc that presents a variety of differently positioned and angled surfaces and projections 24h that may assist in removing debris from teeth and/or massage the gum tissues adjacent the teeth.

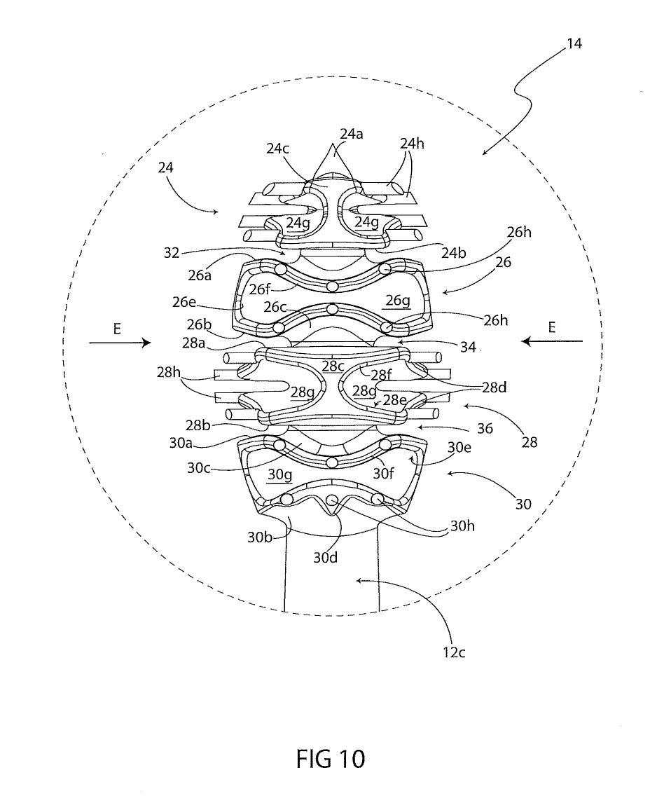

Second disc 26 may be molded to have an upper surface 26a, a lower surface 26b and a peripheral wall 26c extending between upper and lower surfaces 26a, 26b. Upper and lower surface may include flat sections or undulating sections. Peripheral wall 26c may also include undulations that include smooth, convex sections, detents 26d that project outwardly beyond the rest of wall 26c and indentations 26e that are recessed relative to the rest of wall 26c. Once again, detents 26d may be generally V-shaped. Indentations 26e may have beveled edges 26f that transition from an interior wall 26g to the rest of wall 26c. A plurality of cylindrical rod-like whiskers or projections 26h may extend outwardly from one or more of the detents 26d, indentations 26e, edges 26f, interior wall 26g and the rest of wall 26c. Projections 26h may be spaced circumferentially from each other, may be spaced longitudinally from each other, and may be of different lengths. Each projection 26h may be oriented generally horizontally and at right angles to longitudinal axis “Y” of head 14 and extend radially outwardly therefrom. Second disc 26 is thus, again, presents a multi-faceted exterior surface that is suitable for sweeping and scraping debris from teeth. A gap 32 (FIG. 10) may be defined between lower surface 24c of first disc 24 and upper surface 26a of second disc 26.

Third disc 28 may be molded to have an upper surface 28a, a lower surface 28b and a peripheral wall 28c extending between upper and lower surfaces 28a, 28b. Upper and lower surfaces 28a, 28b and peripheral wall 28c may include flat sections or undulating sections. Peripheral wall 28c may include detents 28d that project outwardly beyond the rest of wall 28c and indentations 28e that are recessed relative to the rest of wall 28c. Detents 28d may be generally V-shaped. Indentations 28e may have beveled edges 28f that transition from an interior wall 28g to the rest of wall 28c. A plurality of cylindrical rod-like whiskers or projections 28h may extend outwardly from one or more of the detents 28d, indentations 28e, edges 28f, interior wall 28g and the rest of wall 28c. Projections 28h may be oriented to be generally at right angles to longitudinal axis “Y” and be of various lengths. Projections 28h may extend radially outwardly from longitudinal axis “Y”. Third disc 28 thus presents a multi-faceted exterior surface suitable for sweeping food particles or plaque from the child's teeth. A gap 34 (FIG. 10) may be defined between lower surface 26c of second disc 26 and upper surface 28a of third disc 28.

Fourth disc 30 may be molded to have an upper surface 30a, a lower surface 30b and a peripheral wall 30c extending between upper and lower surfaces 30a, 30b. Upper and lower surfaces 30a, 30b and peripheral wall 30c may include flat sections or undulating sections. Peripheral wall 30c may include detents 30d that project outwardly beyond the rest of wall 30c and indentations 30e that are recessed relative to the rest of wall 30c. Detents 30d may be generally V-shaped. Indentations 30e may have beveled edges 30f that transition from an interior wall 30g to the rest of wall 30c. A plurality of thin, rod-like cylindrical projections 30h may extend outwardly from one or more of the detents 30d, indentations 30e, edges 30f, interior wall 30g and the rest of wall 30c. Projections 30h take the place of bristle tufts typically used to sweep food particles and plaque from teeth. The projections 30h presented rounded edges that are less likely to injure gum tissue during brushing. While each projection 30h may be of a substantially constant diameter along its entire length, an alternative embodiment may include providing gradually tapering projections.

Projections 30h may be spaced circumferentially from each other, may be spaced longitudinally from each other, and may be of different lengths. Each projection 30h may be oriented generally horizontally and at right angles to longitudinal axis “Y” of head 14 and extend radially outwardly therefrom. Fourth disc 30 thus may present a multi-faceted exterior surface suitable for massaging gum tissue and sweeping debris and particulate material from a child's tooth. A gap 36 (FIG. 10) may be defined between lower surface 28c of third disc 28 and upper surface 30a of fourth disc 30. Peripheral wall 30c of fourth disc 30 may taper in diameter from proximate upper surface 30a thereof to proximate lower surface 30b thereof. Lower surface 30b defines the opening to recess 14c therein.

It will be understood that head 14 may include fewer than four discs 22 or may include more than four discs 22. The upper and lower surfaces of the various discs 22 may be spaced from each other as illustrated in FIGS. 7-10 or the upper and lower surfaces may be adjacent each other. As discussed above, each disc may include sections of the annular peripheral wall (24c, 26c, 28c, 30c) that are smooth and convex or some or all of the discs may be free of such sections. Each disc may include detents (24d, 26d, 28d, 30d) and those detents may be generally V-shaped or differently shaped, or some or all of the discs may be free of such detents. Each disc may include indentations (24e, 26e, 28e, 30e) with beveled transitions 24f, 26f, 28f, 30f) and recessed interior walls (24g, 26g, 28g, 30g) or some or all of the discs may be free of some or all of the indentations, transitions or recessed interior walls. Each disc may include the generally cylindrical rod-like projections (24h, 26h, 28h, 30h) that are circumferentially and/or longitudinally spaced from each other and are oriented generally perpendicular to longitudinal axis “Y” or some or all of the discs may be free of such projections or the spacing circumferentially or longitudinally may be changed or the orientation relative to longitudinal axis “Y” may differ.

As indicated earlier herein, head 14 may be injection molded around one end of handle 12 or head 14 may be molded to be an integral, monolithic, unitary component that is engaged with handle 12. Alternatively, some or all of the discs 22 may be molded as separate components that are individually engaged with and secured to shaft 12c of handle 12 to progressively form head 14. Whichever way head 14 is fabricated, head 14 presents a variety of differently angled and shaped surfaces, i.e., the various walls, indentations, detents, edges and projections. These different surfaces or facets all aid in ensuring that, when toothbrush 10 is used by positioning head 14 in contact with the gum tissue and teeth in the baby or young child's mouth, the gum tissue is stimulated and the teeth are cleaned. Additionally, the multi-faceted, multi disc head 14 is also effective in holding dentrifice, mouthwash or other fluid or paste between the discs 22 and dispersing the same slowly and substantially continuously during the brushing event.

Because head 14 is generally circular in cross-section and is multi-faceted around its outer circumference, i.e., presents a variety of differently angled and positioned regions, surfaces and/or projections around its circumference, i.e., through 360°; it is unnecessary for the young child or the caregiver to rotate head 14 within the mouth in order to brush upper and lower teeth. In typical bristled toothbrushes the toothbrush has to be flipped through 180° in order to bring the bristled surface that was in contact with the upper teeth into contact with the lower teeth or vice versa. In the embodiment of toothbrush 10 shown in FIGS. 1-12, 360° of the head's exterior surface is capable of being used to brush the gums and teeth of the child's upper jaw or lower jaw. It should also be noted that in this version of toothbrush 10, handle 12 is usable in any direction or orientation so that any part of head 14 may be used to brush the child's teeth. Handle 12 is free of any structures or components that require handle 12 to be held in any particular orientation in order for the toothbrush 10 to be useful. In other words, handle 12 is free of any flat surfaces, areas to rest the thumb and fingers etc. that will require the handle to be held in a particular orientation during use.

Since rubber or a soft plastic may be used to form head 14, some types of material used in head 14 may be too soft to adequately clean the teeth or stimulate the gums. In this instance, additional materials may be added to the rubber (or the soft plastic) to enhance the brushing power of head 14. For example, an abrasive material such as perlite or pumice could be included as an additive in the material for head 14. Additionally or alternatively, sanitizing materials could be included or even small metallic particles could be introduced as additives. These additives could be advantageous because the plastic or rubber used for head 14 is softer, smoother, and doesn't have sharp points in the same manner as bristles and bristle tufts used in currently known bristled toothbrushes.

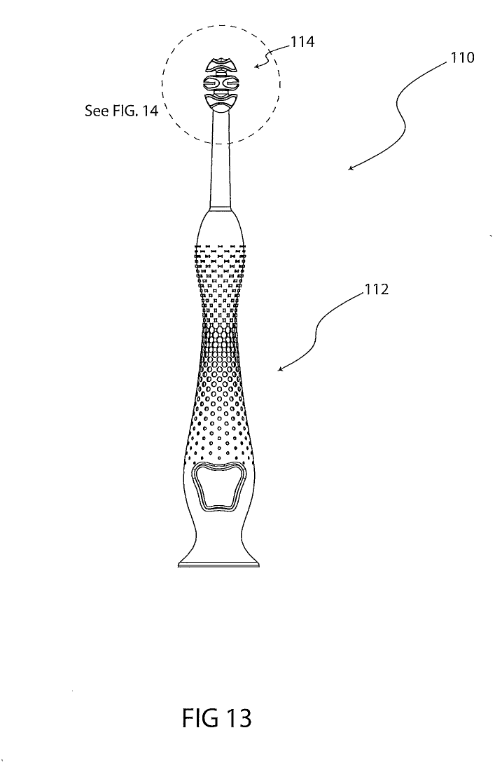

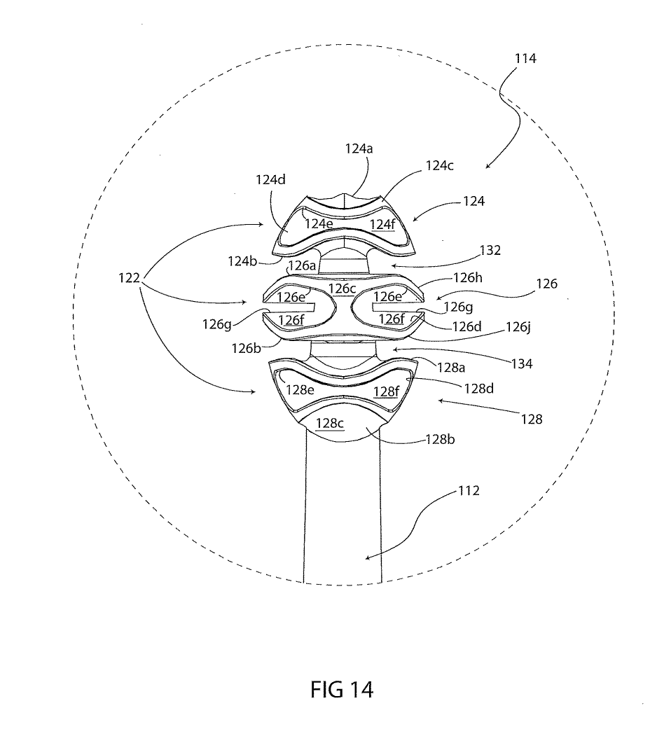

FIGS. 13 and 14 show a second embodiment of a toothbrush in accordance with an aspect of the invention, where the toothbrush is identified by reference number 110. Toothbrush 110 is designed for use on an infant or a very young child. Toothbrush 110 is comprised of a handle 112 and head 114. Handle 112 is substantially identical to handle 12 and therefore will not be further described herein. Head 114 is similar to head 14 in that it is comprised of an injection molded component that includes a plurality of multi-faceted discs 122. In particular, head 114 includes a first disc 124, a second disc 126 and a third disc 138. First disc 126 forms an upper portion of head 114 and third disc 128 forms a lower portion of head 114. A first gap 132 is defined between first and second discs 124, 126; and a second gap 134 is defined between second and third discs 126, 128. In accordance with an aspect of toothbrush 110, all of the first, second and third discs may be free of rod-like whiskers or projections similar to projections 24h. Instead, discs 124, 126, 128 present smoother, convex, detented and indented peripheral walls. This configuration therefore has a smoother exterior surface and is more suitable for infants and young children as this exterior surface is gentler on gum tissue. (The configuration of head 14 with the more complex and more multi-faceted discs that include projections 24h, 26h, 28h and 30h, is more suited to older children with more mature teeth. Projections 24h-30h aid in sweeping food particles and plaque from the more mature teeth but could inadvertently irritate gum tissue, particularly gum tissue that is inflamed because of teething.)

As illustrated in FIG. 14, first disc 124 may have a tip 124a that is less pronounced in length and sharpness than tip 24a. First disc 124 may also include a lower surface 124b, an annular peripheral wall 124c, indentations 124d with gently curved edges 124e, and a recessed interior wall 124f. Peripheral wall 124c may flares outwardly and downwardly from tip 124a and be widest proximate lower surface 124b.

Second disc 126 may have an upper surface 126a, a lower surface 126b, an annular peripheral wall 126c, indentations 126d with edges 126e and a recessed interior wall 126f. In addition, second disc 126 may include one or more radial or annular slots 126g defined in one or more indentations 126d or in peripheral wall 126c. These slots 126g aid in holding dentrifice, liquids, paste etc. in head 114 and increase the flexibility of second disc 126. Upper and lower surfaces 126a, 126b may include annular curved regions 126h, 126j that each angle toward the other.

Third disc 128 may have an upper surface 128a, a lower surface 128b and an annular peripheral wall 128c that tapers from upper surface 128a to lower surface 128b. Third disc 128 may also include one or more indentations 128d with edges 128e and a recessed interior wall 128f. The tapered curvature of peripheral wall 128c may be such that this portion of head 114 presents a generally smooth but faceted surface that will be less inclined to injure gum tissue when swept across the same.

As with head 14, head 114 may be generally circular in cross-section and thus presents 360° of faceted surfaces that may be used to stimulate the young child's gums and clean early and less mature teeth.

It will be understood that head 114 may be comprised of a single shaped disc or may be comprised of two discs or more than three discs. Each of these discs may include smooth regions, recessed regions, edges or slots or may be free of some or all of these faceted surfaces.

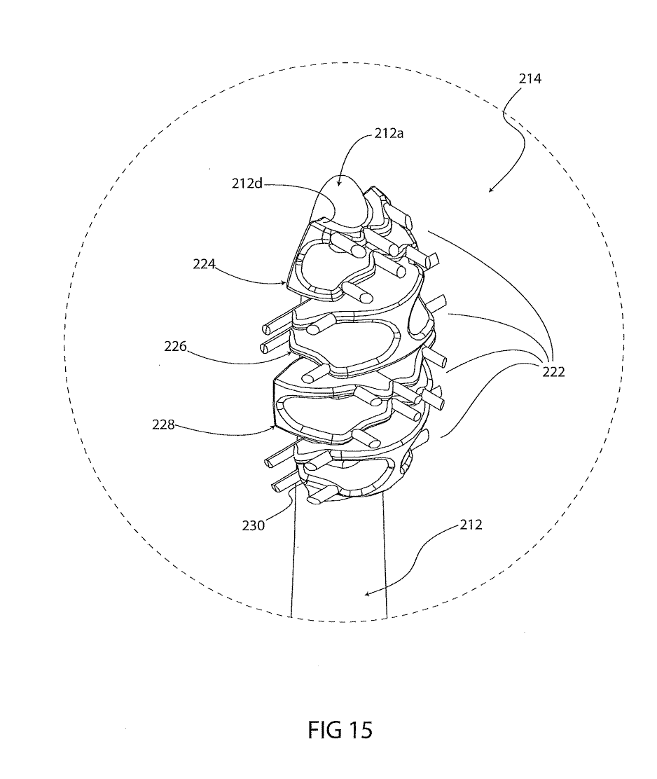

Referring now to FIGS. 15-17, there is shown a third embodiment of a head for a toothbrush, generally indicated at 214. Head 214 may be designed to be engaged with a handle that may be similar to handles 12, 112 or a handle that includes components that particularly require handle 12 to be grasped in a specific orientation. Head 214 will be injection molded around or otherwise engaged and secured to one end of a shaft 212c of such a handle.

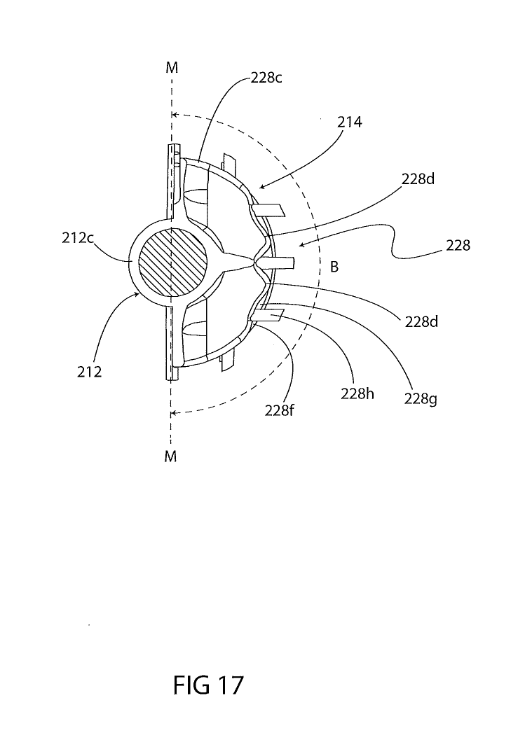

Head 214 may be made up of a plurality of multi-faceted disc members 222, including a first disc member 224, a second disc member 226, a third disc member 228 and a fourth disc member 230. First disc member 224 may include a generally semi-circular region of first disc 24; second disc member 226 may include a generally semi-circular region of second disc 26; third disc region 228 may include a generally semi-circular region of third disc 28; and fourth disc 230 may include a generally semi semi-circular region of fourth disc 30. The semi-circular disc members 224-230 extend outwardly and forwardly from a midline “M-M” (FIG. 17) of shaft 212c and occupy about 180° (indicated by arrow “B” in FIG. 17) of the circumference of head 214. The semi-circular regions of disc members 222 fans out from longitudinal axis through the angle of about 180°. Shaft 212c may include a cut-out region 212d into which the interior ends of each of the first, second, third and fourth disc members 224-230 are received and secured. The first end 212a of the associated handle forms the back region of the uppermost end of head 14.

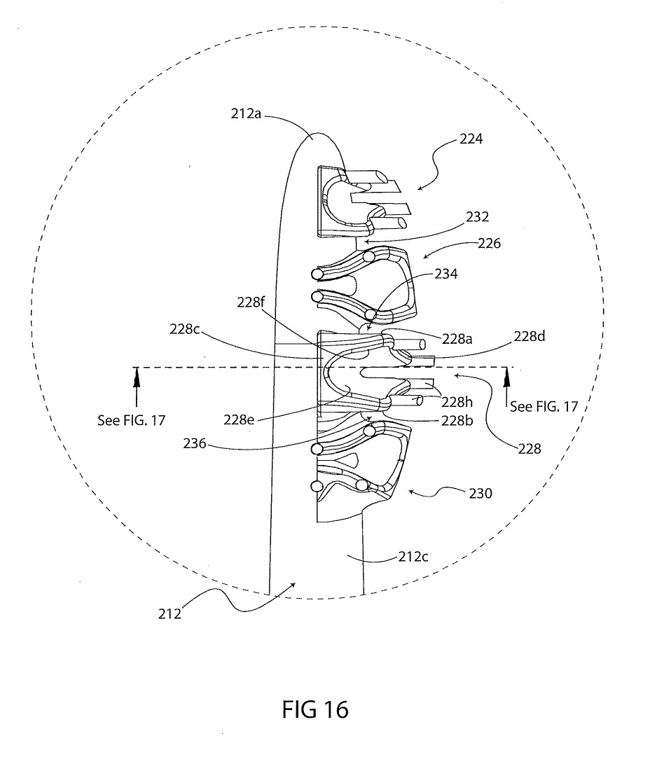

Each of the disc members 224-230 includes upper and lower surfaces with a peripheral wall extending therebetween, and detents, indentations, beveled edges, recessed interior walls, and projections that are substantially similar to those described with reference to first, second, third, and fourth discs 24-30. So as can be seen in FIGS. 16 and 17, disc member 228 includes an upper surface 228a, a lower surface 228b, a peripheral wall 228c, detents 228d, indentations 228e, edges 228f, a recessed wall 228g, and cylindrical projections 228h. As is evident from FIGS. 16 and 17, disc members 224, 226, 228, 230 extend outwardly from shaft 212c of handle 212 in a semi-circular arc; in which all of disc members 224-230 are all located vertically one below the other. A gap 232 is defined between first disc member 224 and second disc member 226. A gap 234 is defined between second disc member 226 and third disc member 228. A gap 236 is defined between third disc member 228 and fourth disc member 230. FIG. 17 also shows that the first, second, third and fourth disc members 224-230 do not all extend outwardly from a front end of shaft 212c to the same extent. FIG. 17 shows that first disc member 222 extends outwardly from shaft 212c to a lesser extent than all the other discs 226-230, and third disc member 228 extends out further than all the other discs, 224, 226, 230. Any desired configuration of the individual disc members may be utilized (e.g. including projections, detents, etc.), any number of disc members may form head 214, and any desired configuration of the stacking of disc members 224-230 may be utilized to produce improved results during gum stimulation or brushing.

It should be noted that in this third embodiment of head 214, the side of shaft 212 opposite disc members 224-230 is free of discs. Because of this, a toothbrush including shaft 212 and head 214 can only be used in a particular orientation instead of through 360° as is the case with the first and second embodiments.

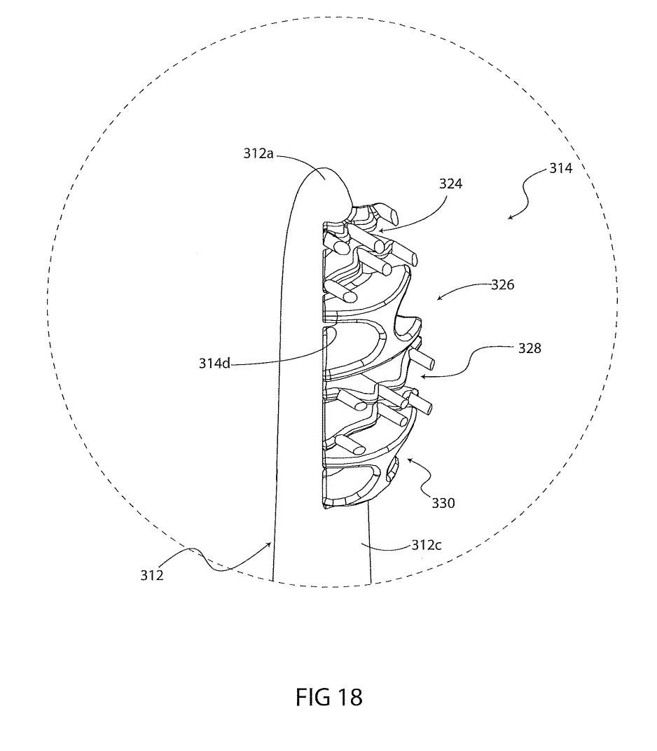

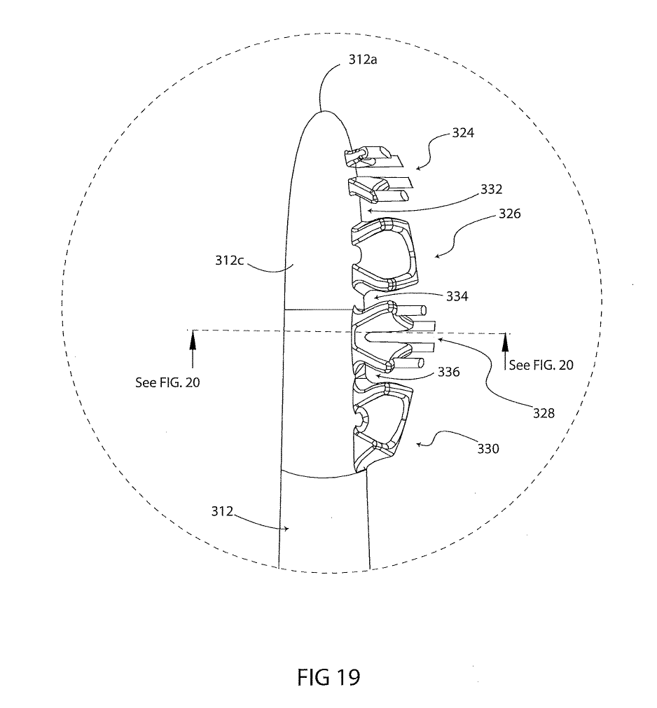

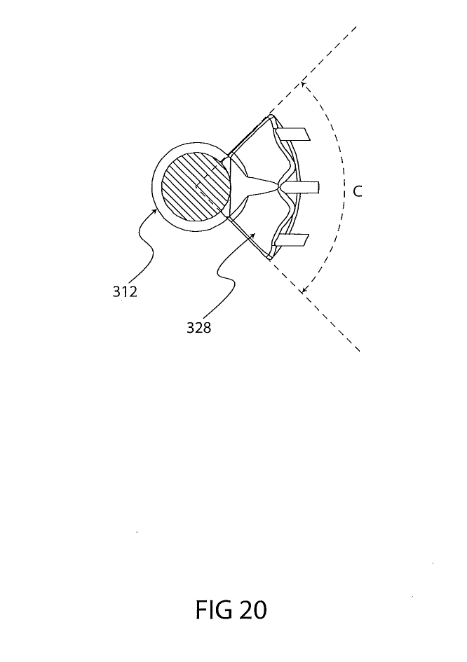

Referring to FIGS. 18-20, there is shown a fourth embodiment of a head for a toothbrush for younger children, with the toothbrush head being indicated by reference number 314. Head 314 is substantially similar to head 214 except that instead of the disc members 324, 326, 328, 330 being semi-circular in shape when viewed from above and fanning through about 180°, each disc member 324-330 fans out through about 90° of the total circumference of head 314 (indicated by arrow “C” in FIG. 20). As with head 214, the first, second, third and fourth disc members 324-330 have a first end that may be integrally molded with shaft 312c or be received in a cut-out region of shaft 312c of handle 312. Each of the first, second, third, and fourth disc members 324-330 includes the upper and lower surfaces, peripheral walls, indentations, edges, recessed walls, and projections of discs 24-30. Disc members 324-330 substantially each comprise one quarter of the related, first, second, third or fourth discs 324, 334.

First disc member 324 is separated from second disc member 326 by a gap 332; second disc member 326 is separated from third disc member by a gap 334; and third disc member 326 is separated from fourth disc 330 by a gap 336. Disc members 324-330 are vertically stacked one above the other. The opposite side of shaft 312c is free of any discs and therefore handle 312 is of a configuration that requires the handle to be used in a particular orientation.

The method of producing any of toothbrushes 10, 110, 210, 310 will be described with reference to handle 12 and head 14 but applies equally to all other handles 112, 212, 312 and heads 114, 214, 314. The method includes injection molding the inner core of handle 12 in a first mold. This step may include forming shaft 12c as a unitary component with the rest of handle 12. The inner core is injection molded from a rigid material, such as ABS plastic. The inner core is then placed in a second mold and a resilient, elastomeric material, such as rubber, is injection molded around the inner core. The second mold may be of a shape that causes the rubber to flow entirely around the inner core and form discs 22 and a suction cup at base 12g of handle 12. The molded toothbrush is then removed from the second mold and the toothbrush 10 shown in FIG. 1 is the result of this process.

Brush head 14 requires a far more complex injection mold than do any of the other heads 114, 214 or 314 because of the presence of rod-like whiskers or projections. The mold for toothbrush head 14 may be opened in the normal fashion but could also include two additional slides that open perpendicular to the normal mold-opening axis. In other words, the mold opens in four quadrants to form projections 24h, 26h, 28h and 30h. FIGS. 9 and 10 show the two molding directions “D” and “E” that are required to mold head 14. After molding is completed, the mold is opened in the opposite directions to “D” and “E” to reveal the complex molded head shown in FIGS. 9 and 10.

It should be noted that toothbrushes 10, 110, 210 and 310 are all designed to be manual toothbrushes.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration set out herein are an example and the invention is not limited to the exact details shown or described.

1. A toothbrush head for a toothbrush, wherein the toothbrush head comprises:
a bulbous body adapted to be located at one end of a handle; wherein said body includes a first end and a second end and a longitudinal axis extending between the first and second ends; and wherein the body comprises:
a first disc;
a second disc located generally vertically beneath the first disc;
wherein each of the first and second discs has a peripheral surface; and
a plurality of faceted regions formed on the peripheral surface of each of the first and second discs.

2. The toothbrush head as defined in claim 1, wherein the first and second discs are oriented at right angles to the longitudinal axis of the body.

3. The toothbrush head as defined in claim 1, wherein the faceted regions include detents and indentations.

4. The toothbrush head as defined in claim 1, further comprising a plurality of generally cylindrical projections extending outwardly from the peripheral surface of one or both of the first and second discs.

5. The toothbrush head as defined in claim 4, wherein the cylindrical projections are oriented at right angles to the longitudinal axis.

6. The toothbrush head as defined in claim 4, wherein the cylindrical projections extend radially outwardly from the peripheral surface of the one or both of the first and second discs.

7. The toothbrush head as defined in claim 1, wherein a gap is defined between the first disc and the second disc.

8. The toothbrush head as defined in claim 1, wherein the toothbrush head includes an inner core fabricated from a rigid material and a sheath provided around at leatt a part of the inner core; wherein the sheath is fabricated from a resilient material; and wherein the first and second discs comprise part of the sheath.

9. The toothbrush head as defined in claim 8, wherein the inner core is an injection molded plastic; and wherein the sheath is an injection molded elastomeric material.

10. The toothbrush head as defined in claim 1, further comprising a third disc located vertically beneath the first and second discs, wherein the first, second and third discs are vertically aligned with each other; and wherein the third disc includes a peripheral surface that includes a plurality of faceted regions.

11. The toothbrush head as defined in claim 10, wherein a first gap is defined between the first disc and the second disc, and a second gap is defined between the second disc and the third disc.

12. The toothbrush head as defined in claim 1, wherein the first and second discs comprise annular rings that extend through 360° around the longitudinal axis of the body.

13. The toothbrush head as defined in claim 1, wherein the first and second discs fan out through about 180° from the longitudinal axis of the body.

14. The toothbrush head as defined in claim 1, wherein the first and second discs fan out through about 90° from the longitudinal axis of the body.

15. The toothbrush head of claim 1 in combination with a handle, wherein the handle is free of components that require the handle to be held in a particular orientation use; and wherein the first and second discs extend for about 360° about the longitudinal axis.

16. The toothbrush head of claim 1 in combination with a handle, wherein the handle includes components that require the handle to be held in a particular orientation during use; and wherein the first and second discs extend for about 90° from the longitudinal axis or for about 180° from the longitudinal axis of the body.

17. The toothbrush head as defined in claim 15, wherein an upper region of the handle includes a tapered shaft around which the body is engaged; and wherein the handle is injection molded from a rigid material and the body is injection molded around the rigid material and is comprised of an elastomeric material.

18. The toothbrush head as defined in claim 1, wherein the head is free of bristles.

19. A method of fabricating a head for a toothbrush comprising steps of:
forming an inner core out of a rigid material;
forming a sheath around at least a part of the inner core from a resilient material;
forming a plurality of discs in the sheath; wherein the discs are oriented at right angles to a longitudinal axis of the inner core; where a portion of the inner core and a portion of the plurality of discs form a body at one end of the inner core.

20. The method as defined in claim 19, wherein the step of forming a plurality of discs includes molding the discs to include a faceted peripheral surface.

21. The method as defined in claim 20, wherein the step of forming the faceted peripheral surface includes molding a plurality of cylindrical projections that extend radially outwardly from the longitudinal axis of the inner core; and such that the projections are oriented generally at right angles to the longitudinal axis.

22. The method as defined in claim 21, wherein the step of forming the faceted peripheral surface includes molding projections that are longitudinally and circumferentially spaced from each other.

23. The method as defined in claim 19, wherein the step of forming the plurality of discs includes selectively forming a plurality of discs that comprise about 90° of an outer circumference of the body; or about 180° of the outer circumference of the body, or about 360° of the outer circumference of the body.

24. A method of training a child to brush their teeth using a toothbrush; where the child ages from infancy up to when their teeth are fully mature; said training method comprising the steps of:
brushing an infant child's teeth with a toothbrush having a head that resembles a nipple of an infant soother;
brushing the young child's emerging teeth and gum tissue with a toothbrush having a head that comprises a plurality of resilient discs which each have multi-faceted outer surfaces;
brushing the older child's teeth with a toothbrush having a head that comprises a plurality of resilient discs which each have multi-faceted outer surfaces and include a plurality of cylindrical projections extending outwardly from the outer surfaces; and
brushing the child's fully mature teeth with a toothbrush having a head that incudes a plurality of bristle tufts.
